(19) United States
(12) Patent Application Publication
(10) Pub. No.: US 2016/0071067 A1
(43) Pub. Date: Mar. 10, 2016

(54) METHOD OF ESTABLISHING PROCESS OPERATIONAL FRAMEWORK IN ACCORDANCE WITH CONTEXT CONCEPT

(71) Applicant: NATIONAL CHUNG SHAN INSTITUTE OF SCIENCE AND TECHNOLOGY, LONGTAN TOWNSHIP (TW)

(72) Inventors: TZU-MING CHAN, LONGTAN TOWNSHIP (TW); WEN-HAO HSIAO, LONGTAN TOWNSHIP (TW)

(21) Appl. No.: 14/476,873

(22) Filed: Sep. 4, 2014

(51) Int. Cl. G06Q 10/10

(52) U.S. Cl. CPC G06Q 10/1097

(57) ABSTRACT

A method of establishing a process operational framework in accordance with a context concept is introduced. The method involves establishing a process operational framework in accordance with a context concept in a manner that the process operational framework thus established applies to the process-oriented streamlining of an enterprise information system, project execution, and the other working needs. The method is flexible and adaptive to different enterprise operation context in terms of working, reduces the time and financial resources spent on customizing systems for use by different customers, and enhances the ease of maintenance of the enterprise process management system.

### FIELD OF TECHNOLOGY

The present invention relates to organization working process establishing methods, and more particularly, to a method of establishing a process operational framework in accordance with a context concept.

### BACKGROUND

Specific information processing processes of an enterprise, such as project management, system engineering management, and product management, are always put on a schedule logically. Nonetheless, the focuses on personnel, environment, and management vary from organization to organization and thus cannot be governed by a single invariable system. Any professional information system tailored to a single customer's needs incurs high production costs inevitably. Hence, it is necessary to adjust a professional information system in terms of organization framework and job requirements in order for the professional information system to be shared between different types of organizations. Since every organization is unique in terms of the program version of its professional information system in use, it is increasingly intricate and difficult for a producer to construct and maintain an increasing number of program versions of the professional information system in use.

Some organizations whose workflow is relatively invariable carry out information process management with a workflow management system characterized in that administrators can define processes in advance and then handle the processes in a predetermined logical sequence during an execution session. The workflow management system is suitable for use by any organization whose management workflow is relatively invariable. However, the workflow management system has the following disadvantages: although the administrator staff can be dynamically appointed so as to suit a special status, the workflow management system itself cannot be adjusted according to the status of the organization, and thus the workflow management system demonstrates little flexibility in application.

The concept “context” refers to specific information for use in defining the status of an object, wherein the object is exemplified by a human being, space, or a message about how a user is associated with an item being used by the user. Furthermore, the concept “context” refers to information pertaining to the surroundings of an object, such as information pertaining to time and date, location, and group. Context analysis involves giving considerations to parameters and criteria related to the surroundings of the object, including, for example, evaluating a building according to its year of construction, and judging the features of an artist's works according to his or her nationality or place of birth. Take an enterprise operation context as an example, the fundamental framework of an enterprise is as follows: an organization launches a process in a specific environment and yields information upon completion of a job. Hence, the parameters required for the enterprise context include organization, surroundings, process, and information. However, the organization varies from enterprise to enterprise in terms of size, a process varies from enterprise to enterprise in terms of complexity, and information varies from enterprise to enterprise in terms of volume. Also, when it comes to the same enterprise, the organization, process, and information vary from project to project. Given a sufficiently large number of context-oriented criteria, there can be comprehensive and accurate execution of jobs and assessment of observed findings. During the stage of the development professional information systems, it is of vital importance that the information systems in operation are sufficiently flexible to suit different enterprise operation context while being dedicated rather than versatile, with their invariable parts being embodied in the system information entity framework and processing units. The system operation of various enterprises is defined by a configuration procedure. It is necessary that data created in the background of an operation process can be readily distinguished, stored, and isolated, so as to meet the requirements of the enterprise process framework.

### SUMMARY

In view of the aforesaid drawbacks of the prior art, the present invention provides a method of establishing a process operational framework in accordance with a context concept. The method involves establishing a process operational framework in accordance with a context concept in a manner that the process operational framework thus established applies to the process-oriented streamlining of an enterprise information system, project execution, and the other working needs. Unlike the prior art, the present invention is flexible to a certain extent, demonstrates a high degree of adaptation to different enterprise operation context as far as working is concerned, reduces the time and financial resources spent on customizing systems for use by different customers, and enhances the ease of maintenance of the enterprise process management system.

The present invention provides a method of establishing a process operational framework in accordance with a context concept. The method comprises the steps of: establishing a context model; entering the context model into a process driving engine; and processing activities and events arising from a process of operating the process driving engine, according to predetermined process operation criteria and rules, so as to drive dynamic operation of the process. In an embodiment, data created during the process operation is stored in a database.

The present invention provides a method of establishing a process operational framework in accordance with a context concept, wherein the step of establishing the context model further comprises: defining a baseline of the context model; performing system entity adjustment; performing entity input frame adjustment; performing activity units adjustment; performing process unit adjustment; performing rules adjustment; performing context situation adjustment; and performing a context model checking procedure so as to attain an adjusted context model. In an embodiment, the method further comprises the step of establishing a system context situation and database according to the adjusted context model.

The present invention provides a method of establishing a process operational framework in accordance with a context concept, wherein the step of operating the process driving engine comprises: putting, in an event queue, an event resulted from the process and expected to be processed; performing event registration; updating a context situation; comparing process operation criteria, activities criteria, and rules attributed to the context model and predefined to relate to the event; and starting a trigger of the event.

The context applicable to the present invention comprises an organization framework, working process steps, worker's job assignment, and information processing and the processing flow thereof Take enterprise context as an example, enterprise context is defined as the structure of a process of enterprise operation, the role played by a person taking part in the process, information processed by and resulting from the process, status manifested by a specific information entity, and specific enterprise operation rules. The concept “enterprise context” means that, depending on its operation mode, the structure of similar working processes (such as needs and requirements yield process) of individual enterprises features combinations of different activities (i.e., constituent elements of a process), and different characters' participation. In the course of an activity, the structure of the information being processed and process operation rules may be identical in some aspects but different in the other aspects, and thus an enterprise context model with unique features can be exhibited when the aforesaid parameters are defined with a method. All the states pertaining to the criteria of specific entity data to be identified and analyzed are defined in advance. The states thus defined are included in the enterprise context model and thus also known as context situation model. During the execution stage of the enterprise working process, the information system constructs the enterprise context model in accordance with the constituent elements of a process (i.e., activities), and assigns jobs to the workers in accordance with predetermined criteria and a rule starting process. While working is taking place, data pertaining to each related information entity is continuously and dynamically updated, and feedback is sent to streamline the updating of a context situation. When it comes to the application of rules governing enterprise process operation, it is necessary to make reference to any related context situations, so as to dynamically adjust the current process or start another process.

The present invention discloses a method of establishing a process operational framework in accordance with a context concept. The disclosed context-based process operational framework is novel. An information entity being processed by the system is adjusted in accordance with the organization context, whereas a process being processed by the system is also adjusted in accordance with the organization operation context. The present invention is further characterized in that: with a novel context driving engine, an information system processing process is developed in accordance with specific context (such as a project, a product, and a customer) so as to drive a process.

To render the features and advantages of the present invention more obvious and comprehensible, the present invention is hereunder illustrated with specific embodiments, drawings, and a detailed description.

### BRIEF DESCRIPTION

Objectives, features, and advantages of the present invention are hereunder illustrated with specific embodiments in conjunction with the accompanying drawings, in which:

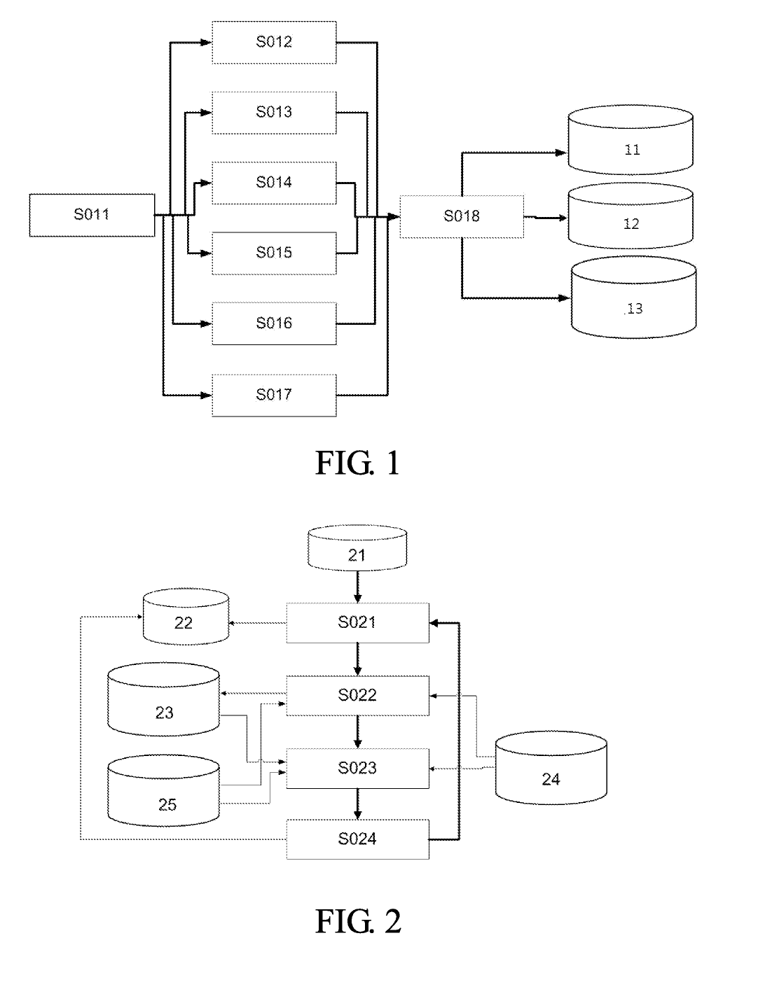

FIG. 1 is a schematic view of the process flow of a procedure of establishing a context model according to the present invention;

FIG. 2 is a schematic view of the process flow of a procedure of operating a process driving engine according to the present invention; and

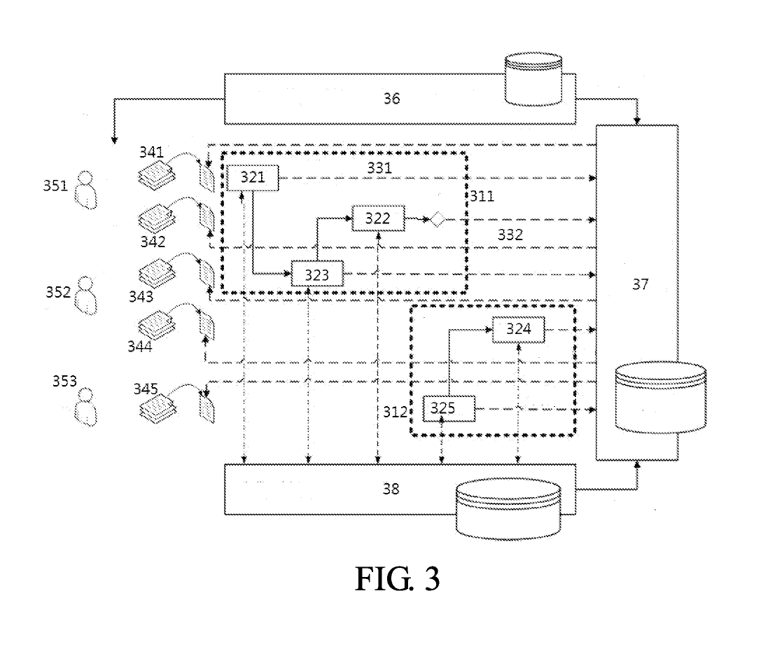

FIG. 3 is a schematic view of a specific embodiment of the present invention.

### DETAILED DESCRIPTION

The present invention provides a method of establishing a process operational framework in accordance with a context concept. The method comprises the steps of: establishing a context model; entering the context model into a process driving engine; and processing activities and events arising from a process of operating the process driving engine, according to predetermined process operation criteria and rules, so as to drive dynamic operation of the process. In an embodiment, all related data created during the process operation is stored in a database. A process defined according to the present invention consists of one or more activities. The process starts as soon as it meets an entry criterion, and the process ends as soon as it meets an exit criterion. The execution of each activity begins as soon as the activity meets a trigger criterion, and the execution of each activity ends as soon as the activity meets a completion criterion.

The method of establishing a process operational framework in accordance with a context concept according to the present invention is exemplified by the construction of an enterprise process management system. In this regard, the purpose of establishing the context model is to: adjust the information entity in the enterprise process management system from the established information entity baseline framework according to the requirements of the enterprise operation context, by creating new attributes in addition to necessary attributes or adjusting data format and length of necessary attributes; and combining and adjusting the processes in the enterprise process management system from the established process baseline unit according to the requirements of the enterprise operation context, by determining the sequence of starting the activity units of the processes, starting criterion and activity assignment principles, and streamlining the information entity adjustment performed to the information entity input frame operated by individual activity units spontaneously. Referring to FIG. 1, the step of establishing the context model further comprises: defining a baseline of the context model S011, including defining a fundamental system entity, defining a fundamental process unit, defining a fundamental activity unit, defining a fundamental operation rule, and defining a fundamental context situation model; performing system entity adjustment S012, including adjusting a selective attribute, an expansion attribute, and attribute length and format; performing entity input frame adjustment S013, including selecting a frame field and displaying a field name; performing activity units adjustment S014, including adjusting the characters which conduct the activities, adjusting an input frame, a trigger criterion, and a completion criterion; performing process unit adjustment S015, including adjusting activities combinations and relationships, an entry criterion, and an exit criterion; performing rules adjustment S016, including setting rules; performing context situation adjustment S017, including setting the information framework and items of the context situation model; and performing a context model checking procedure S018, including attaining an adjusted enterprise context model 11, and creating a context situation data 12 and an enterprise database 13 in accordance with the adjusted enterprise context model 11, wherein process operation-related data is stored in the enterprise database 13, and the process operation in its entirety is carried out in accordance with the enterprise context model 11 thus adjusted.

The method of establishing a process operational framework in accordance with a context concept according to the present invention is exemplified by the construction of an enterprise process management system. In this regard, referring to FIG. 2, the steps of operating the process driving engine comprise: event registration S021, including putting in an event queue 21 all those events which arise from the process but have not yet been processed, taking the events from the event queue 21 in sequence to perform registration on the events, and recording the events in an event record storage area 22; updating the context situation S022, including searching an enterprise database 25 for entity data affected by the events and updating a related context situation data 23 in accordance with an enterprise context model 24 thus adjusted and defined with the context situation model; comparing rules S023, including comparing the process operation criteria, activities criteria, related enterprise rules, and criteria of the enterprise context model 24 thus adjusted in accordance with context situation data and entity data pertaining to the events, and, when it is determined that the aforesaid criteria match each other, taking actions corresponding to rule setting, including updating entity data and starting a trigger; starting trigger S024, including assigning activities to related workers and updating the processing status-related data stored in the event record storage area. Upon completion of the execution of the aforesaid steps, the process flow goes back to the event registration step S021 which entails taking the events from the event queue 21 in sequence to perform registration on the events until the event queue 21 becomes empty. All the data arising from the process driving engine operation is stored in the enterprise database 25. All the aforesaid events occur at the end of the course of process or activities operation. The events are sent to the process driving engine and processed therein. The trigger operation involves starting a new process, a new activity, and a new work.

Referring to FIG. 3, the method of establishing a process operational framework in accordance with a context concept according to a specific embodiment of the present invention is exemplified by the construction of an enterprise process management system. In this regard, enterprise operation involves multiple process 311, 312 to be executed, wherein the processes each include multiple activities 321, 322, 323, 324, 325 to be executed, the event 331 to be executed, and the trigger 332 to be executed, and each involve workers 351, 352, 353 in charge of the execution of jobs 341, 342, 343, 344, 345. One of the objectives of the enterprise process management system is to assign appropriate jobs to each worker so as to conduct the activities and processes step by step and in sequence as follows: establishing an enterprise context model 36 and predefining the context baselines and rules of each process, each activity, and each worker's jobs; entering the enterprise context model 36 into a process driving engine 37, wherein the process driving engine 37 processes activities and the other events, which arise from the processes, in accordance with predefined process operation criteria and rules, wherein the processes start as soon as they meet an entry criterion, and the processes end as soon as they meet an exit criterion, wherein the execution of activities begins as soon as the activities meet a trigger criterion, wherein the execution of activities ends as soon as the activities meet a completion criterion; after all the activities and events in the processes have been fully executed, the process driving engine 37 determines whether to start the next process or stop working, according to the definitions made by the enterprise context model 36 in advance, or, alternatively, the process driving engine 37 starts another process as needed when the preceding process meets a specific criterion. In practice, the process driving engine 37 changes the operation of each process, activity, or event instantly as needed. In an embodiment of the present invention, all the entity data and dynamic data arising from the operation is stored in an enterprise database 38 and thus can be compared and checked in real time in the course of operation or adapted for use as the framework-related reference with respect to subsequent construction of any other enterprise process management systems.

The present invention provides a method of establishing a process operational framework in accordance with a context concept. The method of the present invention is applicable to an enterprise management system, system engineering management, project WBS execution, product development information, a customer service information system, etc. The present invention is also applicable to the cloud-based service framework of a professional information system, supports a multi-tenant application system, and suits different enterprise operation context, and in consequence reduces the time and financial resources spent on customizing systems for use by different customers, and enhances the ease of maintenance of the enterprise process management system.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method of establishing a process operational framework in accordance with a context concept, the method comprising the steps of:
establishing a context model;
entering the context model into a process driving engine; and
processing activities and events arising from a process of operating the process driving engine, according to predetermined process operation criteria and rules, so as to drive dynamic operation of the process.

2. The method of claim 1, wherein the step of establishing the context model further comprises:
defining a baseline of the context model;
performing system entity adjustment;
performing entity input frame adjustment;
performing activity units adjustment;
performing process unit adjustment;
performing rules adjustment;
performing context situation adjustment; and
performing a context model checking procedure, so as to attain an adjusted context model.

3. The method of claim 2, further comprising the step of establishing a system context situation and database according to the adjusted context model.

4. The method of claim 1, wherein the step of operating the process driving engine comprises:
putting, in an event queue, an event resulted from the process and expected to be processed;
performing event registration;
updating a context situation;
comparing process operation criteria, activities criteria, and rules attributed to the context model and predefined to relate to the event; and
starting a trigger of the event.

5. The method of claim 1, wherein data created during the process operation is stored in a database.
